(19) United States
(12) Patent Application Publication
(10) Pub. No.: US 2024/0256586 A1
(43) Pub. Date: Aug. 1, 2024

(54) Method of dualized information theory based Term Frequency Weighting Schemes and Features for Document Representation

(71) Applicant: Arthur Jun ZHANG, Cambridge, MA (US)

(72) Inventor: Arthur Jun ZHANG, Cambridge, MA (US)

(21) Appl. No.: 18/161,067

(22) Filed: Jan. 29, 2023

(51) Int. Cl. G06F 16/33; G06F 16/35

(52) U.S. Cl. CPC G06F 16/3334; G06F 16/3347; G06F 16/355

(57) ABSTRACT

The present invention first develops a novel dualized information theory where both troenpy can quantifying the certainty while entropy can measure the uncertainty. The invention then develops a set of weighting methods for a term using the introduced dual metrics, and these methods makes use of the label information of the documents in the underlying corpus. The invention further proposes a set of class information bias features for each term using the dualized information metric. For various information retrieval and machine learning tasks the invention proposes using these combined features for optimal document representation.

### FIELD OF THE INVENTION

This non-provisional invention application is proposing some original term weighting schemes and features for document representation in the general fields of information retrieval and document intelligence.

This invention extends the classical Shannon information theory, and apply the developed methods to document representation and feature engineering in the field of natural language processing and document classification tasks in machine learning.

The invention relates to the prior art of information entropy, which is a measure of uncertainty, and Inverse Document Frequency (IDF) and its associated Term Frequency Inverse Document Frequency (TF-IDF)[Sparck Jones(1972)], which is a widely used weighting scheme for over a half century.

### BACKGROUND OF THE INVENTION

In information retrieval and machine learning tasks such as ranking and classification, it is a general belief that the underlying data collection contains different amount of information for features, and some features are more informative than other features. In other words, some features play relatively more import role for the considered tasks than other features. In the past several decades researchers have developed various feature weighting methods which assign each feature a weight for optimally quantifying such importance. Most of the algorithms are ad hoc and they leverages the frequency counts information of terms and documents in various ways.

One important observation made by Karen Sparck Jones in 1972 is that if a word w appears in more documents in a corpus collection, then the word is common and it becomes less effective at distinguishing the documents. Inversely, if a word appears in very few documents, then the word is rare and it becomes very effective at distinguishing documents than frequent words. Let's use n denote the total number of documents in the corpus collection and d denote the number of documents containing the word. Then

$$\frac{n}{d}$$

is the reciprocal of the standard document frequency. To avoid the extreme situation of vanishing d=0, a simple smoothing is given by

$$\frac{c + n}{c + d} ,$$

where c is a non-negative real number. By taking the default c=1, this leads to the classical state-of-art Inverse Document Frequency formula:

$$IDF ( w ) = log ( \frac{1 + n}{1 + d} ) .$$

Note one can modify the expression slightly such as

$$log ( \frac{n}{1 + d} ) ,$$

which is trivial.

For the i-th document Dᵢ and the k-th word token wₖ, one can compute the term frequency (TF), denoted as fᵢₖ. It is the counts of the word wₖ in the document divided by the total number of tokens of the document. Then the famous Term Frequency-Inverse Document Frequency (TF-IDF) is just defined as the multiplication of fᵢₖ with IDF, denoted as D_{i,k}=fᵢₖIDF(wₖ).

The IDF approach above comes from the point view of measuring the rareness of a feature and its capability of distinguishing documents. Another more advanced algorithm BM25[Robertson(2009)] further improves the TFIDF by considering the relevance score as a probabilistic problem.

The framework assumes that for two given documents of texts, X and Y, each is regarded as a sequence of word tokens. Ignoring the word orders, we can represent each document as a bag of words V=[w₁, w₂, . . . , wₙ]. Here n is the size of all the vocabulary in the documents. Each document can be first represented as a vector of frequency counts, and then normalized by their total sum of the frequency counts. This finally gives X=[x₁, x₂, . . . , xₙ] and Y=[y₁, y₂, . . . , yₙ], where the two vectors has unit mass. That is, the documents can be regarded as two discrete probability distributions. For a selected weighting method such as TFIDF, for each term w; one computes the weight IDFᵢ. So a document can be represented as a vector consisting of term frequency multiplied with the corresponding weight. For example, X=[x₁·IDF₁, x₂·IDF₂, . . . , xₙ·IDFₙ]

### SUMMARY AND OBJECTS OF THE INVENTION

First the invention proposed a novel dual of the classical Shannon Information Theory[Shannon(1948)], where the proposed dual quantifies the certainty information of the underlying distribution. The dualized information quantities can better and comprehensively represent the underlying distribution in multiple informative ways.

The invention proposes novel term weighting scheme algorithms leveraging the label information of the underlying documents. The prior art algorithms above have not considered using such information before. These document labels contain rich usage pattern information about the terms used in the collection of documents. The proposed weight schemes can effectively summarize the label distribution information and we demonstrated the dramatically improved performance on downstream tasks such as classification in the manuscript[Zhang(2023)] using these proposed weighting schemes. They can also be computed easily at the cost of linear order computational complexity.

The invention proposes a new type of features, namely Class information Bias(CIB) features. The invention further proposes a document representation combing the CIB features, binary term Frequency (BTF) features and the term frequencies weighted using the newly proposed weighting schemes, which we have demonstrated dramatic improvement over the classical TFIDF and the popular optimal transportation methods on popular machine learning tasks such as classification and ranking etc.

### BRIEF DESCRIPTION OF DRAWINGS

FIG. 1 gives a brief summary of the label weighting computing flow procedure for a collection of documents and a term word w. The method starts with a collection of document in step 100, and then collects the class label counts for all the possible classes in step 102. In step 104, for each document the method check if a term w is present in the document, thus divides the collection of documents into two groups. In step 110 the method summarizes the class label counts for documents with term w presence and in step 120 it computes the information quantity PCF1 and NCF1. For documents without term w, in step 144 the method summarizes the class label counts and computes the information quantity PCF0 and NCF0. In step 150, the method gives the final information weight PCF and NCF.

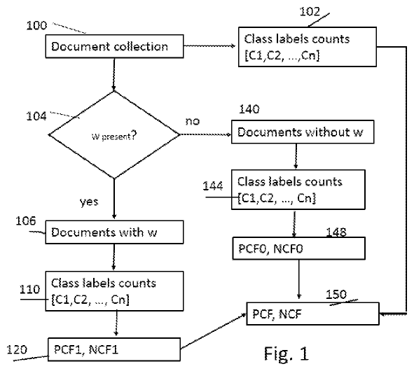

### DETAILED DESCRIPTION OF THE INVENTION

Here we first develop the dualized Shannon information theory. We fix the notations first. Here X indicate a discrete random variables with probability mass function px(x). The Shannon entropy (sometimes also called self-information) measures the uncertainty of the underlying variable, or the level of surprise of an outcome in literature. In this work we purposely call it Negative Information (NI) for showing the duality nature. That is,

$$NI ( x ) := - log ( {p}_{X} ( x ) ) = log \frac{1}{{p}_{X} ( x )} . \qquad ( 1 )$$

Next we define the dual of Negative Information.

We define Positive Information (PI) of an outcome x as

$$P I ( x ) := - log ( 1 - {p}_{X} ( x ) ) = log \frac{1}{1 - {p}_{X} ( x )} . \qquad ( 2 )$$

So PI has the same value range [0, ∞) as NI. Note if we denote x̅ the complement of outcome x, then PI(x)=NI(x̅). Now we propose a dual quantity of entropy, namely troenpy, to measure the certainty of X. It also inversely reflects the level of similarity or commonness of the X′ outcomes. Troenpy is simply the distributed positive information, while entropy measures the distributed Negative Information (NI).

The troenpy of a discrete random variable X′ is defined as the expectation of the PIs,

$$T ( x ) := - {\sum }_{x} {p}_{X} ( x ) log ( 1 - {p}_{X} ( x ) ) . \qquad ( 3 )$$

For continuous X, the differential troenpy is formally defined correspondingly if the integral is finite,

$$T ( x ) := - \int {p}_{X} ( x ) log ( 1 - {p}_{X} ( x ) ) dx . \qquad ( 4 )$$

Note conceptually if the certainty increases, it means certain outcome gains more weight and the similarity and commonness of the overall outcomes decreases correspondingly.

We fix the notations here for a collection of documents. For a corpus of documents, we use n denote the total number of documents. For a pair of documents, we use the indexes i and j and denote the documents as Dᵢ and Dⱼ. For token or symbol features, we use w to denote a generic work. We use m denote the total number of features. The k-th feature is denoted as wₖ, where k∈{1, . . . , m}. The total number of a generic feature w; in the corpus is the classical document frequency, denoted as dₖ∈{0 . . . , n}. The total counts of a token wₖ in a document Dᵢ is denoted as cᵢₖ, and the corresponding term frequency is denoted as fᵢₖ. It is the ratio of cᵢₖ with the total token counts in the document. That is

$${f}_{i k} = \frac{{c}_{i k}}{{\sum }_{t = 1}^{m} {c}_{i t}} \qquad ( 5 )$$

A label for a document Dᵢ is denoted by lᵢ, which is an element of a finite discrete set of all different labels. These labels are usually given directly or could be inferred by some process. For example, for the document classification task, the label of a document is simply the class label of the document.

Next we will propose some dualized information theory based weighting methods.

For a class label distribution C={C₁, . . . , C_{K}}, where Cᵢ is the count of the i^{th} class label. Normalizing by dividing the total number of documents n gives the probability distribution c={c₁, . . . , c_{K}}, where

$${c}_{i} = \frac{{C}_{i}}{n} .$$

We define Positive Class Frequency (PCF) for C as the troenpy of c. Similarly, Negative (or Inverse) Class Frequency (NCF or ICF) as the entropy of c.

$$PCF ( C ) := Troenpy ( c ) NCF ( C ) := Entrophy ( c ) \qquad ( 6 )$$

For the whole documents collection (abbreviated as DC₀), the PCF of the label Y, denoted as PC F₀ is a constant indicating the certainty level of the base label distribution from the whole distribution at the collection population level. Restricting to the documents with term w present (abbreviated as DC₁), the corresponding PCF is denoted as PCF₁. Similarly, PCF₋₁ denotes the PCF for documents with term w absent (abbreviated as DC₋₁).

Here we define the difference PCF₁−PCF₋₁ as Positive Information Gain (PIG) for a term. Similarly the difference NCF₁−NCF₋₁ as Negative Information Gain (NIG).

We propose using PCF=PCF₁−PCF₋₁+PCF₀=PIG+PCF₀ as a term weighting reflecting the relevant label information. Note PCF₀ is a constant and replacing it with other values numerically has no significant difference from the empirical studies. Similarly, an alternative weighting scheme is given by NCF=NCF₁−NCF₋₁+NCF₀=NIG+NCF₀. Here NCF₀ can also be replaced by other constant values without changing the performance significantly. One can also use the transform format of the proposed weighting such as taking the exponential transform, or weighted average of PCF and NCF. Note in the classical TF-IDF and BM25 setting, there is no usage of label information.

To combine the IDF, NCF and PCF, we propose using their multiplication PCF·IDF and NCF·IDF respectively, abbreviated as PIDF and NIDF, as the weighting. Hence multiplying with the term frequency gives the name TF-PIDF and TF-NIDF. Note one can use simply PCF or NCF also rather than the combined one. So in our setting each document can be represented as a vector of word token frequencies with selected weighting methods applied.

Next the invention proposes the following class information bias features. Here we introduce an odds ratio style new feature. This was inspired by an algorithm called Delta-IDF. In a two class sentiment classification setting, [Martineau and Fanin(2009)] proposed taking the difference of the IDFs between the documents of the positive class and the documents of the negative class and then multiplying with the TF gives their delta-TFIDF. Note the difference between the IDFs of the two collections of documents are exactly the odds ratio of the documents counts for the two complementary collections of documents. Motivated by this, we note one can compute the IDF difference for any class, and we call it the Class Information Bias (CIB).

For a fixed term, we further generalize this class bias features by taking the expectation of CIB across all possible class labels. And we can define the same for the dual PDF as we do for IDFs. Thus for each term w we define two distributed Class Information Bias (CIB) features. For a term w, we use n_{w} denote the number of documents with w present and n_{iw} denote the number of documents with class label i and w present. Then the CIB are precisely given by the following.

$$\begin{matrix}CIB ‐ IDF ( w ) := {\sum }_{i = 1}^{K} \frac{{C}_{i}}{n} ( log \frac{{C}_{i}}{1 + {n}_{i w}} - log \frac{n - {C}_{i}}{1 + {n}_{w} - {n}_{i w}} ) \\ CIB ‐ PDF ( w ) := {\sum }_{i = 1}^{K} \frac{{C}_{i}}{n} ( log \frac{{C}_{i}}{1 + {C}_{i} - {n}_{i w}} - log \frac{n - {C}_{i}}{1 + n - {C}_{i} - {n}_{w} + {n}_{i w}} )\end{matrix} \qquad ( 7 )$$

Here note the expression

$$( log \frac{{C}_{i}}{1 + {n}_{i w}} - log \frac{n - {C}_{i}}{1 + {n}_{w} - {n}_{i w}} )$$

is the odd-ratio for the document counts with the term for the i-th class. Similarly, the expression

$$( log \frac{{C}_{i}}{1 + {C}_{i} - {n}_{i w}} - log \frac{n - {C}_{i}}{1 + n - {C}_{i} - {n}_{w} + {n}_{i w}} )$$

is the odds-ratio for the document counts without the term for the i-th class.

Here we define the binary term frequency (BTF), which is simply a binary feature for each term w, it is 1 if w is present in a document and it is 0 if it is absent in a document. BTF gives the most naive representation of a document, regardless of frequency counts.

So a document can use not only the weighted term frequency terms but also the CIB and BTF features jointly to represent the document content as a vector.

Note the normalized weights also have a value when a feature is absent in a document. In order to use such information, the invention proposes first computing the negative term frequencies, denoted as nf, by counting if each feature is present in a document. That is, if a feature is present in a document, nf(wₖ)=0, otherwise nf (wₖ)=1. Thus the normalized weight for the absence of features gives each document representation as Dᵢ=[nfᵢ₁PDF(w₁)], . . . , nfᵢₘPDF(wₘ)], where the PDF(wₖ) here is the default value when the feature is absence in a document. Similarly NDF gives Dᵢ=[nfᵢ₁NDF(w₁)], . . . , nfᵢₘNDF(wₘ)], and PNDF gives

$${D}_{i} = [ {nf}_{i 1} PNDF ( {w}_{1} ) ] , … , {nf}_{i m} PNDF ( {w}_{m} ) ] .$$

At the sentence level, using SNDF weighting gives Xᵢ=xᵢSNDF_{XY}(wᵢ) and Yⱼ=yⱼSNDF_{XY}(wⱼ). Similarly, using SPNDF or its variant weighting gives Xᵢ=xᵢSPNDF_{XY}(wᵢ) and Yⱼ=yⱼSPNDF_{XY} (wⱼ). We will also need do one more re-normalization before solving the corresponding optimization problem. The rest can be computed in the standard OT framework as above.

While the various embodiment of the present invention have been described above, it should be understood that they have been presented by way of example, and not limitation. As it is easy for a skilled person to make various changes in form and detail therein without departing from the spirit and scope of the invention. It is also to be understood that the following claims are intended to cover all of the generic and specific features of the invention herein described and all statements of the scope of the invention which, as a matter of language, might be said to fall there between.

### BIBLIOGRAPHY

[Martineau and Fanin(2009)] Justin Martineau and Tim Fanin. 2009. Delta tfidf: An improved feature space for sentiment analysis. Third international AAAI conference on weblogs and social media. 7
[Robertson(2009)] S. Robertson. 2009. The Probabilistic Relevance Framework: BM25 and Beyond. Foundations and Trends® in Information Retrieval, 3(4):333-389. 2
[Shannon(1948)] Claude Elwood Shannon. 1948. A mathematical theory of communication. The Bell System Technical Journal, 27:379-423. 3
[Sparck Jones(1972)] Karen Sparck Jones. 1972. A statistical interpretation of term specificity and its application in retrieval. Journal of documentation, 28(1):11-21. 1
[Zhang(2023)] Arthur Jun Zhang. 2023. A novel dual of shannon information and weighting scheme. proceedings of ACL. 3

What is claimed:

1. A term weighting method leveraging document labels for a corpus of documents, comprising: an information quantity of the label class counts for documents with the term presence; and
an information quantity of the label class counts for documents with the term absence.

2. The method of claim 1, further comprise a base constant.

3. The method of claim 1, wherein the information quantity comprise taking the entropy of the corresponding underlying collection of documents.

4. The method of claim 1, wherein the information quantity comprise taking the troenpy of the corresponding underlying collection of documents.

5. The method of claim 1, further comprise a constant, or the entropy, or the troenpy of the document label class counts for the whole document collection.

6. The method of claim 1, wherein the final weighting value comprise an exponential transformation for some constant base such as 2 or natural e etc.

7. A method for computing a term level class information bias feature comprise a distributed component averaging the odds-ratio of Inverse Document Frequencies of the total counts of documents for the specific class count and the count of the documents with the term presence and the class label across all the available classes.

8. The method of claim 7, where the component comprise a distributed component averaging the odds-ratio of Positive Document Frequencies of the total counts of documents for the specific class count and the count of the documents with the term absence and the class label across all the available classes.

9. A method of representing a text document comprising:
a vector of term frequency components for each term, where the term frequency component is the product of a term frequency in the document, a selected document frequency weighting, and a class label weighting component obtained from claim 1.

10. The method of claim 9, further comprise a vector of binary term frequency feature components across all terms.

11. The method of claim 9, further comprise a vector of class information bias feature component across all terms obtained from claim 6.
